(19) United States
(12) Patent Application Publication
(10) Pub. No.: US 2022/0051077 A1
(43) Pub. Date: Feb. 17, 2022

(54) SYSTEM AND METHOD FOR SELECTING COMPONENTS IN DESIGNING MACHINE LEARNING MODELS

(71) Applicant: DARWINAI CORPORATION, Waterloo (CA)

(72) Inventors: Seyed Mahmoud Famouri, Waterloo (CA); Mohammad Javad Shafiee, (US); Brendan Chwyl, Waterloo (CA); Alexander Wong, Waterloo (CA)

(21) Appl. No.: 17/401,096

(22) Filed: Aug. 12, 2021

Related U.S. Application Data
(60) Provisional application No. 63/064,914, filed on Aug. 12, 2020.

(51) Int. Cl. G06N 3/04; G06N 3/08; G06F 16/901

(52) U.S. Cl. CPC G06N 3/04; G06K 9/00154; G06F 16/9024; G06N 3/08

(57) ABSTRACT

Disclosed are example embodiments of systems and methods for selecting components for building graph-based learning machines. An example system for selecting components for building graph-based learning machines includes a reference learning machine, one or more test signals, and a component analyzer module. The component analyzer module is configured to analyze, using the one or more test signals, one or more component in the reference machine by ranking different components in the reference learning machine in terms of their efficiency and effectiveness.

The present application for patent claims priority to U.S. Provisional Application No. 63/064,914, filed Aug. 12, 2020, entitled “System and Method for Selecting Components in Design Machine Learning Models,” and expressly incorporated by reference herein.

### FIELD

The present disclosure relates generally to the field of machine learning, and more specifically to systems and methods for selecting components for building graph-based learning machines using learning algorithms.

### BACKGROUND

One of the main challenges in designing graph-based machine learning models such as deep neural networks is identifying the best graph components to build the model or re-design and fine-tune the model's design architectures. A graph-based machine learning model is a combination of several computational graph components. The selected components should model the data such that the selected components provide the best modeling performance and discriminates the labels the most with an architecture with minimum computational complexity. However, this process is mostly a manual process. Users need to spend a significant amount of time and effort trying different configurations and analyzing them to identify the best configuration from the set of potential architectures.

All configurations need to be trained via the training data to identify the best one which produces the highest performance. As such, identifying the best graph components to build a graph-based model which performs reasonably well in terms of accuracy and computational cost takes a long time and significant effort.

Thus, a need exists for systems, devices, and methods for selecting graph components in designing machine learning models to produce the highest performance and with great accuracy.

### SUMMARY

Provided herein are example embodiments of systems, devices, and methods for selecting components for building graph-based learning machines using learning algorithms.

One general aspect includes a system for selecting components for building graph-based learning machines. The system includes a reference learning machine. The system also includes one or more test signals. Additionally, the system includes a component analyzer configured to analyze, using the one or more test signals, one or more components in the reference learning machine by ranking different components in the reference learning machine in terms of the one or more components' efficiency and effectiveness. Other embodiments of this aspect include corresponding computer systems, apparatus, and computer programs recorded on one or more computer storage devices, each configured to perform the actions of the methods.

One general aspect includes a method of selecting components for building a graph-based learning machine. The method of selecting components includes observing the behavior of a component in a reference learning machine. The method of selecting components also includes ranking the component in the reference learning machine in terms of their efficiency and effectiveness to evaluate the effectiveness of the component. Additionally, the method of selecting components includes identifying issues in the component of the reference learning machine. The method of selecting components also includes generating the graph-based learning machine based on ranking and the issues to design a better learning machine. Other embodiments of this aspect include corresponding computer systems, apparatus, and computer programs recorded on one or more computer storage devices, each configured to perform the actions of the methods.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description, other sections of this document, or both the Details Description and other sections of this document. Such embodiments are presented herein for illustrative purposes only. Additional features and advantages of the invention will be set forth in the descriptions that follow, and in part, will be apparent from the description or may be learned by practice of the invention. The objectives and other advantages of the invention will be realized and attained by the structure, particularly pointed out in the written description, claims, and the appended drawings.

### BRIEF DESCRIPTION OF THE DRAWINGS

The present invention may be better understood by referring to the following figures. The components in the figures are not necessarily to scale. Emphasis instead being placed upon illustrating the principles of the disclosure. In the figures, reference numerals designate corresponding parts throughout the different views.

FIG. 1 illustrates an exemplary system for selecting components for building graph-based learning machines, according to some embodiments of the present invention.

FIG. 2 illustrates another exemplary system for selecting components for building graph-based learning machines, according to some embodiments of the present invention.

FIG. 3 illustrates another exemplary system for selecting components for building graph-based learning machines, according to some embodiments of the present invention.

FIG. 4 illustrates an exemplary system for selecting components for building graph-based learning machines for image classification, according to some embodiments of the present invention.

FIG. 5 illustrates an exemplary system for selecting components for building graph-based learning machines for speech recognition, according to some embodiments of the present invention.

FIG. 6 illustrates an exemplary overall platform for various embodiments and process steps, according to some embodiments of the present invention.

FIG. 7 is a flow diagram illustrating an example method in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The following disclosure describes various embodiments of the present invention and method of use in at least one of its preferred, best mode embodiments, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Generally, embodiments of the present disclosure include systems and methods for evaluating and selecting components to design learning machines, and in particular graph-based learning machines. In some embodiments, the system of the present disclosure may include a reference learning machine, a component analyzer, a set of test signals, a pool of graph components, and the test signals to evaluate the effectiveness of each component in the reference learning machine and the pool of components.

In some embodiments, various elements of the system of the present disclosure, e.g., the reference learning machine and the component analyzer, may be embodied in hardware in the form of an integrated circuit chip, a digital signal processor chip, or on a computer. Learning machines may also be embodied in hardware in the form of an integrated circuit chip or on a computer. The elements of the system may also be implemented in software executable by a processor, in hardware, or a combination thereof.

Generally, a graph-based learning machine (e.g., a deep neural network) includes or is the combination of graph components that are processed sequentially or, in some cases, in parallel to map the input data to the desired output values. The user may select the set of graph components, for example, within a trial and error process where different configurations of the graph components are designed as the learning machine. Constructed architectures are then trained by the training set and are evaluated via the test set to measure the effectiveness of each configuration. This process is time-consuming and tedious since each learning machine architecture needs to be trained before the evaluation. The systems and methods of the present disclosure thus may provide an improved and automatic approach to analyze different graph components in a neural network architecture and measure the graph components' effectiveness more efficiently.

In some embodiments, a pool of potential graph components may be defined. The set of components may either be designed by the user and can have different structures or may be generated automatically. The designed structures may be based on predefined requirements and the applications which need to be solved.

In some embodiments, the graph components in the pool can be constructed automatically given some predefined criteria by the user. The generated components may be semi-randomly generated to satisfy the objectives specified by the user.

A generated graph component may be a combination of a set of operations with a specific processing order. After applying all operations, a graph component may process the input signal by applying the operations with specific order and output the resulting signal.

In some embodiments, the reference learning machine and the set of test signals may be fed as inputs into the graph component analyzer. The graph component analyzer may pass the set of test signals through the reference learning machine and evaluate the effectiveness of each component in the reference learning machine. The set of test signals may be used to understand how the target component processes the real input data and maps the real input data into the embedding space. This mapping process may help the learning machine to discriminate the real input data more effectively. The graph component analyzer may evaluate the discriminating strength of each graph component in the reference learning machine based on the set of test signals and rank the component or different consecutive sets of components (as one big graph component) in the network.

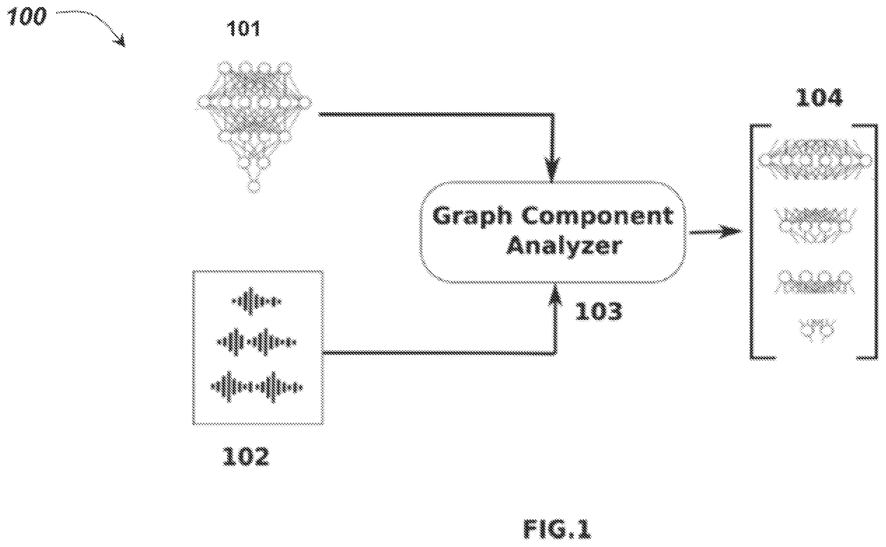

FIG. 1 illustrates an exemplary system 100 for selecting components for building graph-based learning machines, according to some embodiments of the present invention. The system 100 may include a reference learning machine 101 and a set of test signals 102, which may be fed to a graph component analyzer 103. The graph component analyzer 103 observes the behavior of each component in the reference learning machine 101, bypassing the test signals 102 through the graph component analyzer 103. By extracting and aggregating information, the component analyzer 103 can rank different components 104 in the reference learning machine 101 in terms of the components' efficiency and effectiveness.

By ranking the components or a subset of components as a big, unified component in the reference learning machine, the system may evaluate the effectiveness of each component in the network. This ranking would help identify issues in different parts of the reference learning machine and design a better learning machine.

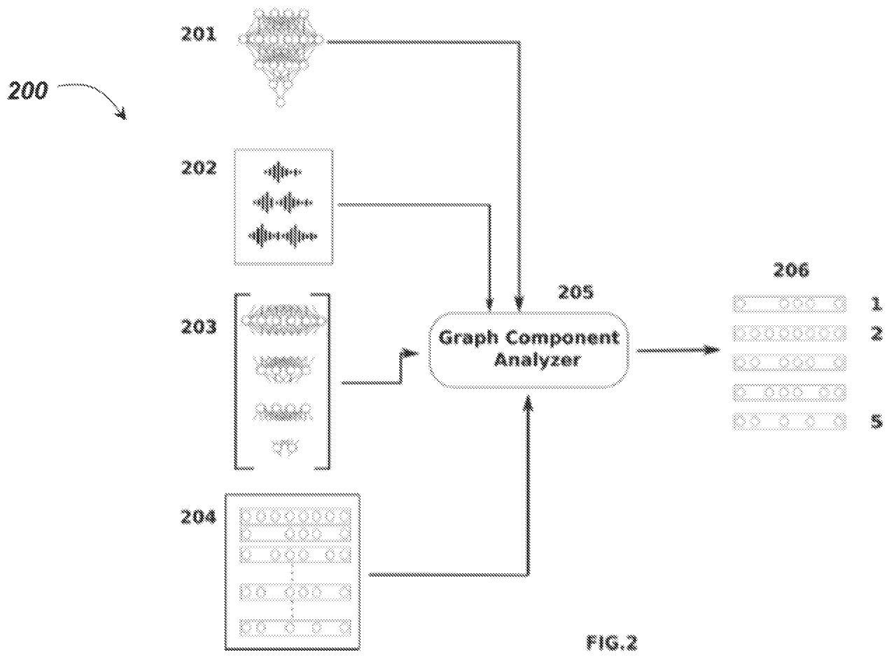

FIG. 2 illustrates another exemplary system 200 for selecting components for building graph-based learning machines, according to some embodiments of the present invention. In some embodiments, it may be important to identify more effective components to replace the non-important components in the reference learning machine. The pool of components 204, the set of test signals 203, and ranking information of the components in the reference learning machine may be fed into the graph component analyzer to measure the effectiveness of the components in the pool 204 to replace non-effective components in the reference learning machine 201. The component analyzer 205 uses the knowledge extracted from the components of the reference learning machine 201 based on the set of input signals (S) 202 to evaluate the effectiveness of each component in the pool 204. The components in the pool may be ranked based on the extracted knowledge from the reference learning machine 201. The goal is to identify the most effective component in the pool 204. Use of the most effective component may improve the performance of the reference learning machine 201 by substituting the unimportant component of the reference learning machine 201.

In some embodiments, the component analyzer 205 F(.) may have four inputs: L=reference learning machine, P=pool of components, S=test signal, C=criteria, where the set of criteria (C) may be used to select the best components. The component analyzer may pass the test signals through the reference learning machine and analyze the behavior of the components in the reference learning machine. The same test signals 202 may be fed to the components in the pool to understand the behavior of the components in the pool and identify the components with the most similarity to the components in the reference learning machine 201. The component analyzer 205 F(.) may then identify the best replacement component 206 in the pool 204 given the criteria C.

In some embodiments, the criteria C may relate to improving the efficiency of the reference learning machine. As such, the selected component from the pool should increase the efficiency of the reference learning machine when the selected component replaces the original component in the reference learning machine.

In some embodiments, the criteria C may enforce better discrimination and better accuracy for the reference learning machine; as such, the component analyzer F(.) may identify those components which increase the ability to discriminate among data in the reference learning machine and improves the performance of the learning machine after they are added to the reference learning machine. While this process may improve the accuracy of the reference learning machine, the process may also increase the complexity of the reference learning machine.

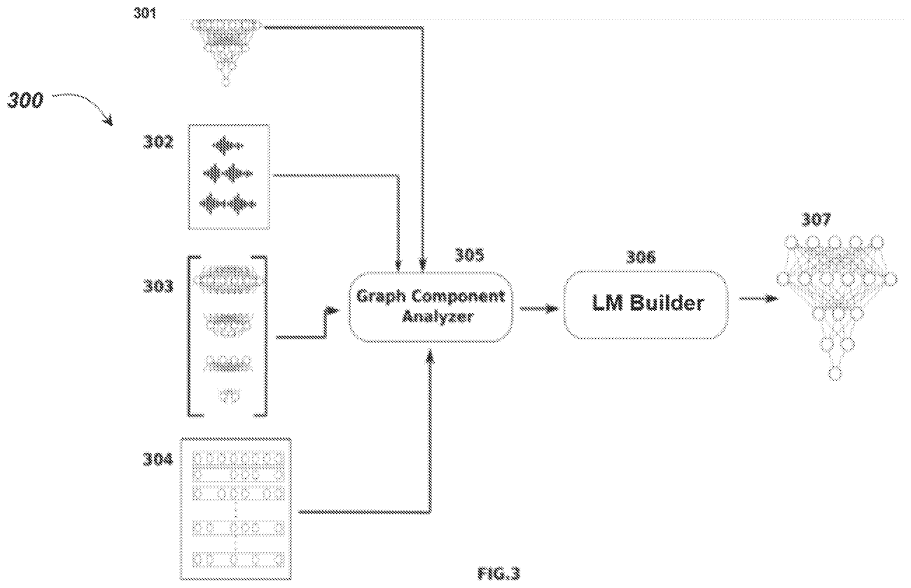

FIG. 3 illustrates another exemplary system 300 for selecting components for building graph-based learning machines, according to some embodiments of the present invention. In some embodiments, the component analyzer 305, F(.) may couple with the learning machine builder 306, B(.), where the extracted knowledge by the component analyzer 305 may be used in the learning machine builder 306 to generate a new learning machine 307. The learning machine builder 306 may use the extracted knowledge from the reference learning machine 301 to identify the effective/efficient and non-effective/non-efficient components in the reference learning machine 301. Some components, which are considered as non-effective components in the reference learning machine, may be larger than necessary to provide the required functionality, or they may be unnecessary. They can be removed entirely without any effect on the learning machine functional accuracy. On the other hand, some components are important in the functional accuracy of the reference learning machine to provide the highest performance, which shows where in the reference learning machine and which components are the main driving force of this functionality and the strength of the reference learning machine.

The component analyzer may evaluate each component in the reference learning machine and measure the importance of that component in the reference learning machine's functional accuracy by using the test signals as the input. This evaluation may then be aggregated, and the weak and robust components in the reference learning machine may be identified.

Given this information, the learning machine builder 306 generates a new learning machine architecture 307 to resolve the identified weaknesses of the reference learning machine 301. The architecture of the generated learning machine 307 designed by the learning machine builder 306 might have some similar graph components and some new components compared to the reference learning machine 301. However, the generated architecture by the learning machine builder 306 is more effective given the criteria C, which can be efficient, accurate, have lower latency for the learning machine, or some combination of these.

In some embodiments, the learning machine builder 306 may generate only one new graph component given the reference learning machine (designed based on only one graph component) 301 to improve accuracy or increase the efficiency of the graph component in the reference learning machine. The learning machine builder 306 analyzes the operations in the reference learning machine 301 and how the operations are connected to each other. Based on the evaluation, the learning machine builder 306 may generate a new component with different architecture and possibly a different set of operations. The generated component by the learning machine builder may be added to the pool of graph components 304, so the learning machine builder may use them to replace the ineffective component in the reference learning machine 301 in the future. The learning machine builder 306 can increase the number of graph components in the pool of components 304 by evaluating more learning machines 301.

In some embodiments, the graph component analyzer 305, F(.) may evaluate the effectiveness of each graph component in the pool 304 given the reference learning machine. The graph component analyzer 305 may evaluate the reference learning machine, and based on the extracted knowledge from the reference learning machine 301, measures the effectiveness of each graph component in the pool 304. The components in the pool 304 may be compared with the components 303 in the reference learning machine 301 and given the set of test signals 302; as such, the components with more similar behavior to the components in the reference learning machines 301 are scored with higher values by the graph component analyzer 305. A graph component in the pool 304 that generates more similar outputs to one in the reference learning machine 301 has a better chance of swapping with one of the components in the reference learning machine.

In some embodiment, the function F(.) may measure the effectiveness of each graph component, given the input signal. The function F(.) may process the input signal through the graph component and measure how effective and efficient the graph component models and represents the input signal. The function F(.) may be formulated in different ways as below, but it is not limited to those approaches. In some embodiments, the function F(.) receives the graph component o_i for each input signal s_i. The set of O={o_i|i is the output corresponding to the signal s_i} is analyzed as below:

F(.)=1/(sum of all input signals(correlation(o_i,s_i)))

The function F(.) may measure how much the graph components change the configuration of input samples after processing them as output O.

In some other embodiments, the function F(.) can be formulated to consider the number of operations in the graph component as well when the function F(.) measures the effectiveness of the graph component:

F(.)=α/nOPS*1/(sum of all input signals(correlation(o_i,s_i)))

where nOPS encodes the number of operations and a is a hyperparameter derived from the predefined criteria, defining how efficient a graph component should be. This new function combines measuring the efficiency and effectiveness of the graph component into one evaluation value.

In some other embodiments, the function F(.) may be formulated based on other similarity metrics between input signals and output of the graph components such as canonical correlation analysis (CCA), singular vector CCA or other variations of correlation analysis, to measure the effectiveness of the graph components in modeling the input signal.

In some other embodiments, the function F(.) may measure based on how many dimensions of the output signals are orthogonal from each other and capable of representing the input signals S:

F(.)=(1/sum_j(trans(O_i)·(O_j))−(1/sum(trans(s_i),s_j)),

where higher F(.) shows that the graph component is more effective in modeling the data.

In some embodiments, the graph component analyzer 305 may evaluate the reference learning machine 301 and all the components of the reference learning machine 301 to identify ineffective graph components and rank their effectiveness. As such, the graph component analyzer 305 may identify the best number of graph components in the reference learning machine 301 to produce a specific performance. The learning machine builder 306 may generate smaller learning machine architectures 307 compared to the reference learning machine given the provided information by the graph component analyzer 305 and evaluate them to determine how many of the graph components in the reference learning machine are unnecessary and removing those from the learning machine would not affect the accuracy performance of the learning machine.

In some embodiments, this functionality can determine the optimal size for the learning machine 301 and generate optimized reference learning machines 307.

The ranking of the graph components in the reference learning machine 301 can be correlated by the accuracy of the generated learning machine, which enables generating learning machines with specific performance given a predefined computational budget. As such, by specifying the available computational power, the learning machine builder 306 may generate a learning machine L with the predefined accuracy and computational power.

In some embodiments, the learning machine builder 306 can tune the graph components in the reference learning machine 301 to optimize the computational power requirement given the specified accuracy. The learning machine builder 306 may replace the graph components in the reference learning machine 301 with some other graph components, which are more efficient while producing the same modeling accuracy level. The generated learning machine 307 produces the same outputs as the reference learning machine given the same inputs.

### Building an Image Classification Learning Machine—Example 1

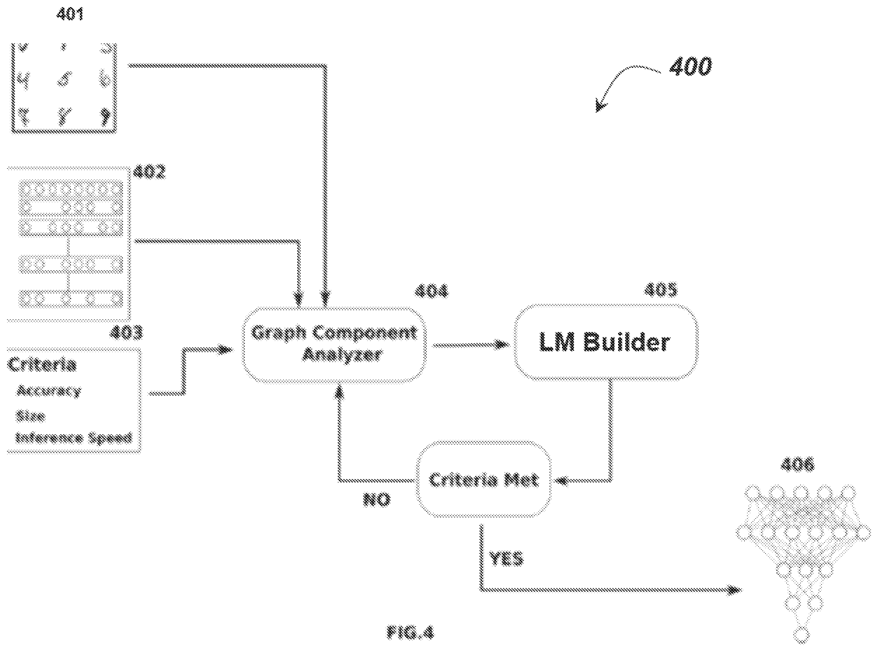

FIG. 4 illustrates an exemplary system 400 for selecting components for building graph-based learning machines for image classification, according to some embodiments of the present invention. System 400 includes an image classification subsystem, takes a learning machine and passes an image into the network, and decides what class label the image belongs to. As shown in FIG. 4, the learning machine builder 405 can generate a learning machine 406 given the set of inputs and desired outputs (the training data for reference learning machine) 401 and the pool of components 402. The learning machine builder 405 adds graph components together step by step while measuring the effectiveness of the learning machine via the graph component analyzer 404 at each step and determines the best component to add to the learning machine in the next step, e.g., based on criteria being met 407. The learning machine builder 405 adds graph components to the learning machine and grows the learning machine 406 given the specified computational budget and required accuracy performance in criteria 403. The learning machine builder 405 stops adding new graph components to the previously generated learning machine 406 until adding a new graph component would not improve the performance of the last reference machine and returns the final learning machine 406 for the image classification application.

### Building a Speech Recognizer Learning Machine—Example 2

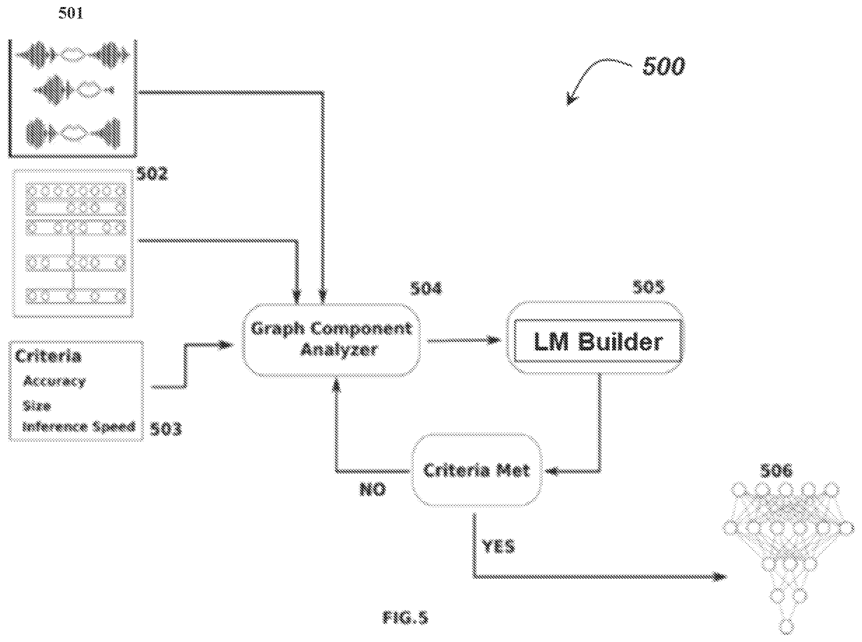

FIG. 5 illustrates an exemplary system 500 for selecting components for building graph-based learning machines for speech recognition, according to some embodiments of the present invention. In FIG. 5, an exemplary speech recognition system 500 produces a learning machine 506 with the signal 501 as the inputs and translates the input signal 501 into the text. The learning machine builder 505 adds components to the learning machine one by one to improve the effectiveness of the generated learning machine 506 in translating the input signal 501 to text accurately and efficiently. The learning machine builder 505 iteratively adds components while this process improves the modeling accuracy of the learning machine L. The graph component analyzer 504 evaluates the current reference learning machine L and the component in the pool 502 to identify whether adding a new component can improve the accuracy of the learning machine L. Whenever the criteria determined by 503 are met 507, the process stops. The new reference learning machine should translate the input signal to text with the highest possible accuracy and with the minimum computational complexity and highest inference speed. The learning machine 506 is outputted for deployment.

System Architecture

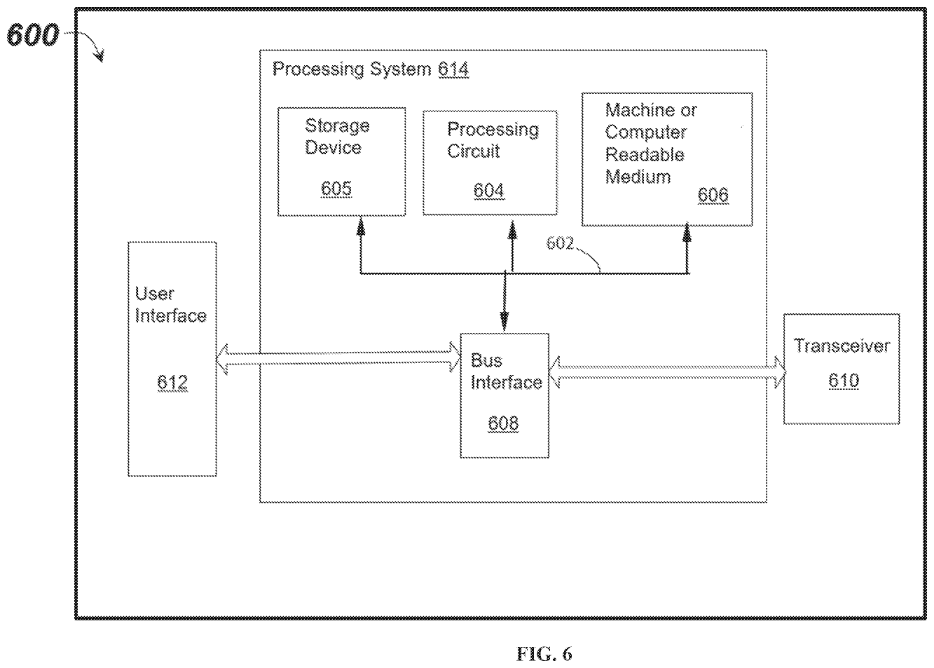

FIG. 6 illustrates an exemplary overall platform 600 for various embodiments and process steps, according to some embodiments of the present invention. FIG. 6 illustrates an exemplary overall platform 600 in which various embodiments and process steps disclosed herein can be implemented. In accordance with various aspects of the disclosure, an element (for example, a host machine or a microgrid controller), or any portion of an element, or any combination of elements may be implemented with a processing system 614 that includes one or more processing circuits 604. Processing circuits 604 may include micro-processing circuits, microcontrollers, digital signal processing circuits (DSPs), field-programmable gate arrays (FPGAs), programmable logic devices (PLDs), state machines, gated logic, discrete hardware circuits, and other suitable hardware configured to perform the various functionalities described throughout this disclosure. That is, the processing circuit 604 may be used to implement any one or more of the various embodiments, systems, algorithms, and processes described above, for example, as in processes 100, 200, and 300 above. In some embodiments, the processing system 614 may be implemented in a server. The server may be local or remote, for example, in a cloud architecture.

In the example of FIG. 6, the processing system 614 may be implemented with a bus architecture, generally represented by the bus 602. The bus 602 may include any number of interconnecting buses and bridges depending on the specific application of the processing system 614 and the overall design constraints. The bus 602 may link various circuits, including one or more processing circuits (represented generally by the processing circuit 604), the storage device 605, and a machine-readable, processor-readable, processing circuit-readable, or computer-readable media (represented generally by a non-transitory machine-readable medium 606). The bus 602 may also link various other circuits such as timing sources, peripherals, voltage regulators, and power management circuits, which are well known in the art and will not be described any further. The bus interface 608 may provide an interface between bus 602 and a transceiver 610. The transceiver 610 may provide a means for communicating with various other apparatus over a transmission medium. Depending upon the nature of the apparatus, a user interface 612 (e.g., keypad, display, speaker, microphone, touchscreen, motion sensor) may also be provided.

The processing circuit 604 may be responsible for managing the bus 602 and for general processing, including the execution of software stored on the machine-readable medium 606. When executed by processing circuit 604, the software causes processing system 614 to perform the various functions described herein for any apparatus. Machine-readable medium 606 may also be used to store data manipulated by processing circuit 604 when executing software.

One or more processing circuits 604 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc., may be passed, forwarded, or transmitted via any suitable means, including memory sharing, message passing, token passing, network transmission, etc.

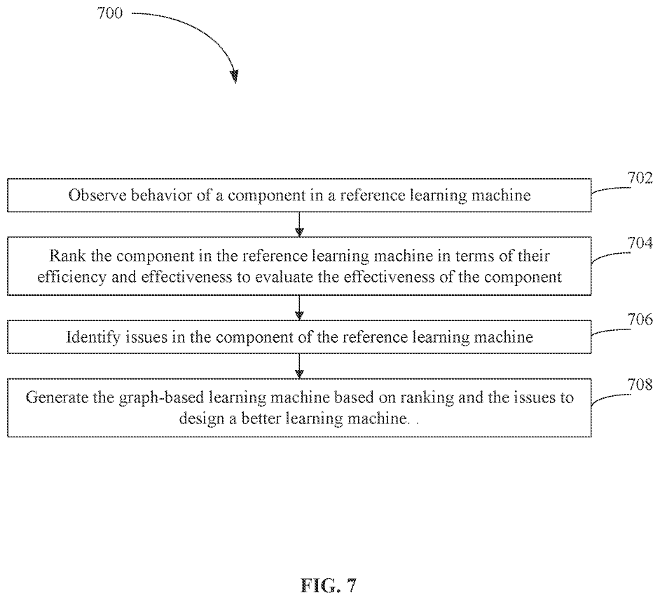

FIG. 7 is a flow diagram illustrating an example method 700 in accordance with the systems and methods described herein. The method 700 may be a method of selecting components for building a graph-based learning machine. The method 700 includes observing the behavior of a component in a reference learning machine (702). The method 700 also includes ranking the component in the reference learning machine in terms of the component's efficiency and effectiveness to evaluate the effectiveness of the component (704). Additionally, the method 700 includes identifying issues in the component of the reference learning machine (706). The method 700 also includes generating the graph-based learning machine based on ranking and the issues to design a better learning machine (708).

Observing the behavior of a component in a reference learning machine (702) may include one or more of detecting the component in the reference machine, monitoring the functioning of the component in the reference machine, and storing data related to the behavior of the component. Ranking the component in the reference learning machine in terms of their efficiency and effectiveness to evaluate the effectiveness of the component (704) may include rating the component relative to other components and preparing an ordered list of such components. The components may be other components that may perform similar tasks or other components in the reference machine. Identifying issues in the component of the reference learning machine (706) may include analyzing the functioning of the component and diagnosing shortcomings in the component. Generating the graph-based learning machine based on ranking and the issues to design a better learning machine (708) may include selecting a replacement component for the better learning machine and replacing the component with the replacement component.

Referring to FIG. 6, in one configuration, an apparatus such as platform 600 may include means for implementing the method 700 of FIG. 7. For example, the apparatus may include components that perform each of the blocks of the algorithm in the aforementioned flowchart of FIG. 6. Each block in the aforementioned flowchart of FIG. 6 may be performed by a component, and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof. The aforementioned means may be one or more of the aforementioned components of the platform 600, including the processing circuit 604 of the platform 600 configured to perform the functions recited by the aforementioned means.

It is understood that the specific order or hierarchy of blocks in the processes/flowcharts disclosed is an illustration of exemplary approaches. It is understood that the specific order or hierarchy of blocks in the processes/flowcharts may be rearranged based on design preferences. Further, some blocks may be combined or omitted. The accompanying method claims present elements of the various blocks in a sample order and is not meant to be limited to the specific order or hierarchy presented.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

It is to be understood that this disclosure is not limited to the particular embodiments described herein, as such may, of course, vary. It is also to be understood that the terminology used herein is for the purpose of describing particular embodiments only and is not intended to be limiting.

Various aspects have been presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, Read Only Memory (ROM) memory, Erasable Programmable Read Only Memory (EPROM) memory, Electrically Erasable Programmable Read Only Memory (EEPROM) memory, registers, hard disk, a removable disk, a Compact Disc Read Only Memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects.

What is claimed is:

1. A system for selecting components for building graph-based learning machines, comprising:
a reference learning machine;
one or more test signals; and
a component analyzer configured to analyze, using the one or more test signals, one or more components in the reference learning machine by ranking different components in the reference learning machine in terms of the one or more components' efficiency and effectiveness.

2. The system of claim 1, wherein one or more analyzed and ranked component in the reference learning machine are replaced with one or more components that are more efficient or more effective.

3. The system of claim 2, further comprises a learning machine builder configured to generate a new learning machine after the reference learning machine includes the one or more components that are more efficient or more effective.

4. The system of claim 1, further comprising a graph component comprising at least one of a node, a set of nodes, or a group of smaller graph components which, given input data, produces a set of outputs.

5. The system of claim 1, further comprising a combination of graph components that model data.

6. The system of claim 5, wherein the graph components are included in a pool of components and wherein the system further defines new components and adds them to the pool of components.

7. The system of claim 1, wherein the component analyzer or graph component analyzer measures an effectiveness of each component in the reference learning machine in terms of modeling performance and the component analyzer, and wherein a graph component analyzer ranks the components based on the one or more components' effectiveness.

8. The system of claim 1, wherein the component analyzer or graph component analyzer evaluates an efficiency of each component in the reference learning machine in terms of computational complexity given the one or more components' effectiveness.

9. The system of claim 1, wherein the component analyzer or graph component analyzer evaluates a performance of graph components listed in a pool of components to be added into the reference learning machine to improve a modeling accuracy and reduce a computational complexity of a new generated learning machine.

10. The system of claim 1, wherein a learning machine builder generates a new learning machine with improved efficiency and modeling accuracy compared to the reference learning machine by identifying the best graph components to be replaced in the reference learning machine and a list of potential components.

11. The system of claim 1, wherein an efficiency of a model may be defined as an inference speed or a memory footprint to process an input signal.

12. The system of claim 1, wherein a learning machine builder generates a new graph component from scratch which is not in a pool of components to improve a performance of the reference learning machine.

13. The system of claim 1, wherein a performance of the reference learning machine is measured in terms of functional accuracy or inference speed.

14. The system of claim 1, wherein a learning machine builder identifies a numbers of graph components and layers in the reference learning machine, given specific performance.

15. The system of claim 1, wherein a learning machine builder builds a new learning machine with an optimized number of components.

16. The system of claim 1, wherein a learning machine builder tunes and re-designs the reference learning machine to provide better performance given learning machine complexity.

17. The system of claim 1, configured to design a new learning machine for an image classification application.

18. The system of claim 1, wherein the system generates a new learning machine to create a speech recognition system.

19. The system of claim 1, wherein an image classifier generates from the reference learning machine may receive an image of a handwritten digit into a network and make a decision on what class the image belongs to.

20. A method of selecting components for building a graph-based learning machine, the method comprising:
observing behavior of a component in a reference learning machine;
ranking the component in the reference learning machine in terms of the component's efficiency and effectiveness to evaluate the effectiveness of the component;
identifying issues in the component of the reference learning machine; and
generating the graph-based learning machine based on ranking and the issues to design a better learning machine.
